(19) United States
(12) Patent Application Publication
(10) Pub. No.: US 2026/0091548 A1
(43) Pub. Date: Apr. 2, 2026

(54) Apparatus and method for transferring a material web and thermoforming machine

(71) Applicant: Kiefel GmbH, Freilassing (DE)

(72) Inventors: Aaron Datscher, Micheldorf (AT); Michael Staudinger, Fridolfing (DE)

(21) Appl. No.: 19/345,002

(22) Filed: Sep. 30, 2025

(30) Foreign Application Priority Data
Oct. 2, 2024 (DE) 10 2024 128 673.3

(51) Int. Cl. B29C 51/44; B29C 51/26

(52) U.S. Cl. CPC B29C 51/445; B29C 51/262

(57) ABSTRACT

An apparatus for transferring a material web in a thermoforming machine is disclosed. The thermoforming machine may have a forming tool. The forming tool is tilted about an axis running transversely to the feed direction of the material web during a forming process. The material web is transported from a forming region of the forming tool of the thermoforming machine to a downstream station of the thermoforming machine. The material web is moved from the forming region to the downstream station, where the transfer apparatus includes a transport unit with a transport device that is displaced in a first direction between the forming tool and the downstream station and is engaged with an initial portion of the material web in a first region facing the forming tool and is disengaged in a second region facing the downstream station.

### PRIORITY CLAIM

The present application claims priority under 35 U.S.C. § 119 to German Patent Application No. DE 102024128 673.3, filed October 2, 2024, the disclosure of which is incorporated by reference herein in its entirety.

### TECHNICAL FIELD

The present disclosure relates to an apparatus for transferring a material web in a thermoforming machine, to a thermoforming machine with a forming tool and an apparatus for transferring a material web, and to a method for transferring a material web from a forming region of a thermoforming machine.

### BACKGROUND

In thermoforming machines with a tiltable tool, a tiltable tool part is pressed against a stationary tool part to form molded parts and then the tiltable tool part is moved relative to the stationary tool part and tilted about an axis running substantially orthogonal to the feed direction of the material web, whereby the molded parts are removed or ejected in the tilted position. During the forming process, the molded parts are released from a material web and the material web with punched-out regions, also known as skeleton or sheet skeleton, is guided out of the forming region. Such thermoforming machines typically include a stacking unit located downstream of the forming region in the feed direction. To start up the thermoforming machine or after a format change, a new material web must be introduced, which is usually done via a transport system (e.g. transport chains) beyond the forming region. There, the material web leaves the transport system and must be guided past the stacking unit. The material web can then be fed to a winding device and/or a mill, for example. Until now, the transfer has been done manually by an operator who had to grasp the beginning of a material web and then manually guide it over the stacking device and from there feed it to the rewinding device or the mill. This often requires the operator to climb a ladder or the thermoforming machine. This poses a significant safety risk for the operator.

### SUMMARY

### OBJECT

One object is to ensure a safe transfer of material webs when machines are started up. A further object is to simplify the transfer of material webs and to provide an alternative solution to manual transfer.

### SOLUTION

The above-mentioned object is achieved by an apparatus for transferring a material web in a thermoforming machine with a forming tool from a forming region of the forming tool of the thermoforming machine to a downstream station of the thermoforming machine, where the forming tool can be tilted about an axis running transversely to the feed direction of the material web during a forming process, including a guide that is designed such that the guide extends from the forming region to the downstream station, and a transport unit with a transport device (e.g., transport means) that can be displaced along the guide between the forming station and the downstream station and can be engaged with the material web in a first region facing the forming station and can be disengaged in a second region facing the downstream station.

Using this apparatus, a material web can be transferred, in particular when the thermoforming machine is started and a new material web is introduced, without an operator having to manually guide the material web from the forming region through further stations (e.g. stacking station). It may only be necessary for an operator to grasp the beginning of the material web after it has passed the forming region and guide it into the first region. The beginning of the material web then engages with the transport device and is moved via the transport device. The transport device can be continuously moving, set in motion to engage with the beginning of the material web in the first region or moved only after engagement. Preferably, the beginning of the material web can be automatically engaged with the transport device. After reaching the second region, the transport device is disengaged from the material web. This can preferably be done automatically, so that the material web is then automatically picked up in the downstream station or inserted or engaged by an operator. The transfer is then completed and the material web can be further processed in the downstream station. For example, the downstream station can be a station for winding the skeleton or a station with a mill for shredding the skeleton. The skeleton is then advanced by the downstream station.

This provides a transfer of a material web from a forming station to a downstream station via at least one further station, e.g. a stacking station, without requiring operators to climb onto the thermoforming machine or use a ladder, thus significantly reducing the risk to life and limb.

After a material web has been formed and molded parts punched out in a forming station, the material web is also referred to as a skeleton or sheet skeleton. In the following, the term “material web after forming” refers to such a skeleton or sheet skeleton. The terms are therefore used synonymously.

This type of transfer is particularly suitable for so-called tilting machines, where a sheet is processed as the material web. The materials used for this purpose can include, for example, conventional polymer materials or plastics, as well as recyclable plastics, such as rPET, bio-based materials, such as PLA, or other common plastics. Furthermore, it is also possible to use the transfer system for material webs made of a fibrous material.

In further embodiments, the transport device can have at least one holding element for engagement. The holding device serves to grip the material web or the skeleton, in particular the beginning of the material web, or to come into contact with it, so that the material web can be moved or pulled together with the at least one holding element of the transport device.

In further embodiments, the transport device can be endless, with only a portion of the transport device having the at least one holding element. An endless transport device can, for example, be designed at least in portions as a chain, belt or strap, with the at least one holding element being arranged on one portion. The transport device can be deflected via at least two deflection elements (bearings, rollers, gears, etc.). At least one of the deflection elements can be driven, or a drive can be provided that sets the transport device in motion at a location other than the deflection points, which are preferably located in the first and second regions. The material web can be engaged with the transport device via the at least one holding element in the first region, for example if the at least one holding element is moved around a deflection roller in the direction of the material web. The at least one holding element then increasingly comes into contact or engagement with the material web. During further movement, the material web is pulled along. In the second region, the at least one holding element is deflected around another deflection roller or the like and guided back, with the at least one holding element automatically releasing the material web.

In such embodiments, the guide can, for example, be arranged so that it engages laterally with the material web. The transport device can be guided in the guide, with the guide additionally having a guide surface on which a lateral portion of the material web rests and over which at least one transport device is pulled.

In further embodiments, the material web is inserted into the guide such that a lateral portion of the beginning of the material web rests on the guide surface of the guide. By deflecting the transport device in the first region via a gear, deflection roller, etc., at least one holding element then engages with the material web or the skeleton and presses the lateral portion against the guide surface from above. As the transport device is further shifted, the material web is moved along the guide surface, with the remaining part of the material web or the skeleton resting on further guide surfaces or rollers. In such an embodiment, advancement can only occur via lateral engagement with the material web. The guide surface ends in the second region, so that the material web is no longer held from below and is released from at least one holding element by gravity. The transfer is then completed, and the at least one transport element is returned to the first region via another deflection roller or the like.

In further embodiments, the at least one holding element can have a needle and/or a clamping element, and/or the transport device can be designed at least in portions as a chain, belt or strap. A needle enables the transport device to easily engage with the edge of the material web or the skeleton.

In further embodiments, the apparatus can have an adjustment unit for the relative displacement of the transport device. The adjustment unit enables displacement of the transport device and, in further embodiments, also of the guide, so that the transport device and the guide can no longer come into contact with the material web or the skeleton. The material web or the skeleton can continue to be guided via rollers or similar devices even after transfer, so that the material web does not sag or move to a further station.

In further embodiments, the transport device can be displaced orthogonally to a feed direction of the material web through the machine. The transport device is moved laterally out of the transport region of the material web. In addition, the guide can be moved out of the transport region, whereby the transport device is preferably displaced together with a drive for it and the guide. The transfer apparatus is only brought into the transport region when a new material web is introduced. The apparatus is then displaced.

In further embodiments, the transport device can be pivoted relative to an axis running orthogonally to a feed direction of the material web through the machine. As an alternative to a lateral displacement, the apparatus in this embodiment is pivoted out of the transport region, whereby an additional lateral displacement can take place in order to move the guide surface of the guide away from the lateral portion of the material web.

The above-mentioned object is also achieved by a thermoforming machine with a forming tool that can be tilted about an axis running transversely to the feed direction of a material web during a forming process, and an apparatus for transferring the material web according to any of the embodiments described above, where a material web or a skeleton is transferred from a forming region of the forming tool of the thermoforming machine to a downstream station of the thermoforming machine.

In further embodiments, at least one further station can be arranged between the forming station and the downstream station and the guide of the transfer apparatus can lead past the at least one further station.

With regard to the thermoforming machine, reference is made to the above advantages resulting from the integration of such a transfer apparatus.

The above-mentioned object is further achieved by a method for transferring a material web from a forming region of a thermoforming machine with a forming tool and with an apparatus for transferring the material web, where the forming tool is tilted about an axis running transversely to the feed direction of the material web during a forming process and where the material web is transported from a forming region of the forming tool of the thermoforming machine to a downstream station of the thermoforming machine, where the transfer apparatus includes a transport unit with a transport device that is displaced in a first direction via a guide between the forming station and the downstream station and is engaged with an initial region of the material web in a first region facing the forming station and is disengaged in a second region facing the downstream station.

In further embodiments, the transport device can be displaced in another direction relative to the guide and/or stopped when the material web has passed the second region.

In further embodiments, during the displacement of the transport device in the first direction, at least one holding device of the transport device can be automatically engaged with the material web when the at least one holding device passes or has passed the first region and can be automatically disengaged when the at least one holding device passes or has passed the second region.

With regard to the method, reference is made to the above advantages, which apply equally.

Further features, embodiments and advantages result from the following illustration of exemplary embodiments with reference to the figures.

### BRIEF DESCRIPTION OF THE FIGURES

In the figures:

FIG. 1 depicts a schematic illustration of stations of a thermoforming machine;

FIG. 2 depicts a schematic illustration of a forming process;

FIG. 3 depicts a schematic illustration of an apparatus for transferring a material web;

FIG. 4 depicts a further illustration of the apparatus from FIG. 3;

FIG. 5 depicts yet a further illustration of the apparatus from FIG. 3;

FIG. 6 depicts an enlarged view of a first region of an apparatus for transferring a material web;

FIG. 7 depicts a further illustration of a first region; and

FIG. 8 depicts a schematic illustration of a second region of an apparatus for transferring a material web.

### DETAILED DESCRIPTION

Various embodiments of the technical teaching described herein are shown below with reference to the figures. Identical reference signs are used in the figure description for identical components, parts and processes. Components, parts and processes that are not substantial to the technical teachings disclosed herein or that are obvious to a person skilled in the art are not explicitly reproduced. Features specified in the singular also include the plural unless explicitly stated otherwise. This applies in particular to statements such as “a” or “one.”

In the following, embodiments of apparatuses 200 and methods for transferring sheets 300 are described with reference to the exemplary embodiments shown.

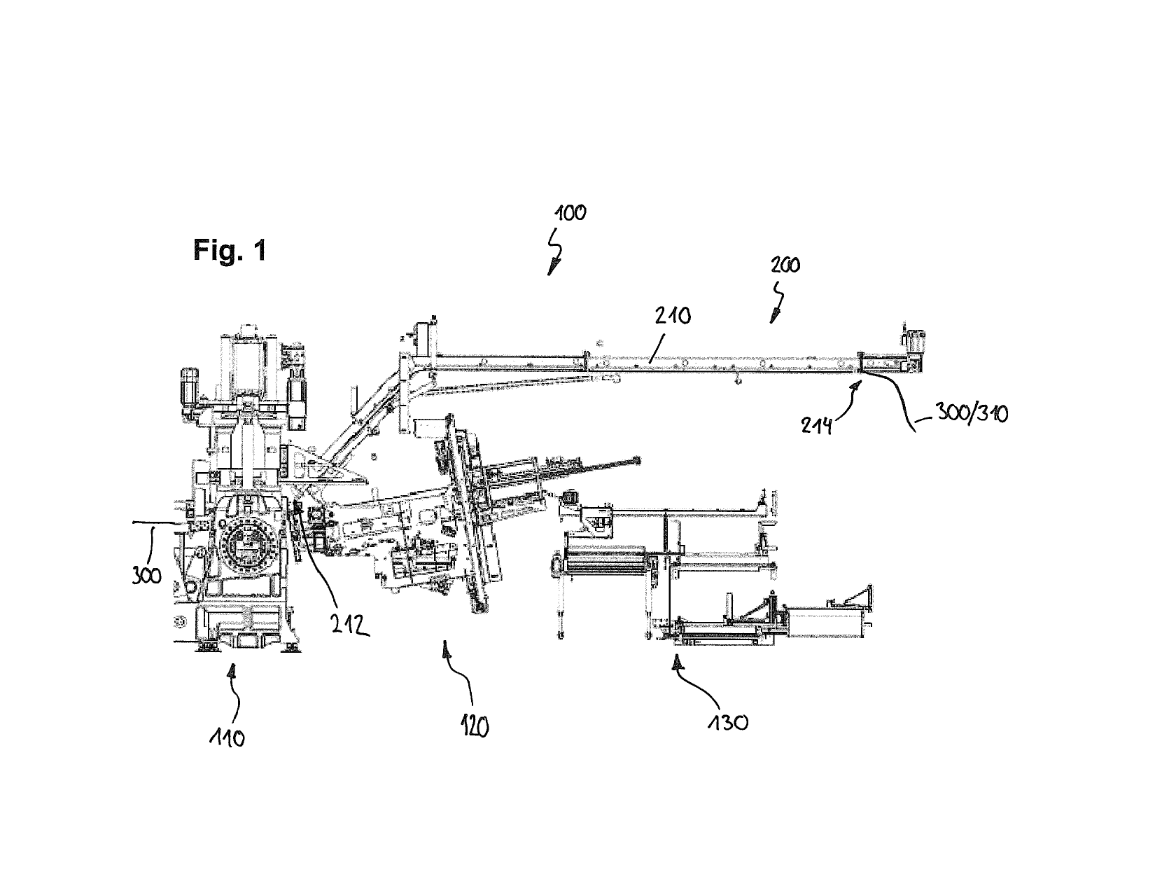

FIG. 1 depicts a schematic illustration of stations of a thermoforming machine for forming a moldable material, which in one exemplary embodiment shown is fed as an endless material web from a roller. The material web can be a sheet 300 made of plastics. For example, plastics sheets made of PET, PP, PS, PLA, PE can be processed.

The thermoforming machine 100 typically includes a heating station (not shown), a forming station 110, a transfer and stacking station 120 and a transport unit 130. Furthermore, the thermoforming machine 100 can have further stations for pretreatment and provision of a sheet 300 as well as for further transport and/or further processing, which are not explicitly described in the exemplary embodiments shown.

The thermoforming machine 100 also has an apparatus 200 for transferring a material web. The apparatus 200 enables the sheet 300 or a skeleton 310 of the sheet 300 to be automatically transferred via at least the transfer and stacking station 120 after forming and punching out molded parts, without an operator having to manually guide the sheet 300 through the stations and, for example, feed it to a winding station or a skeleton mill.

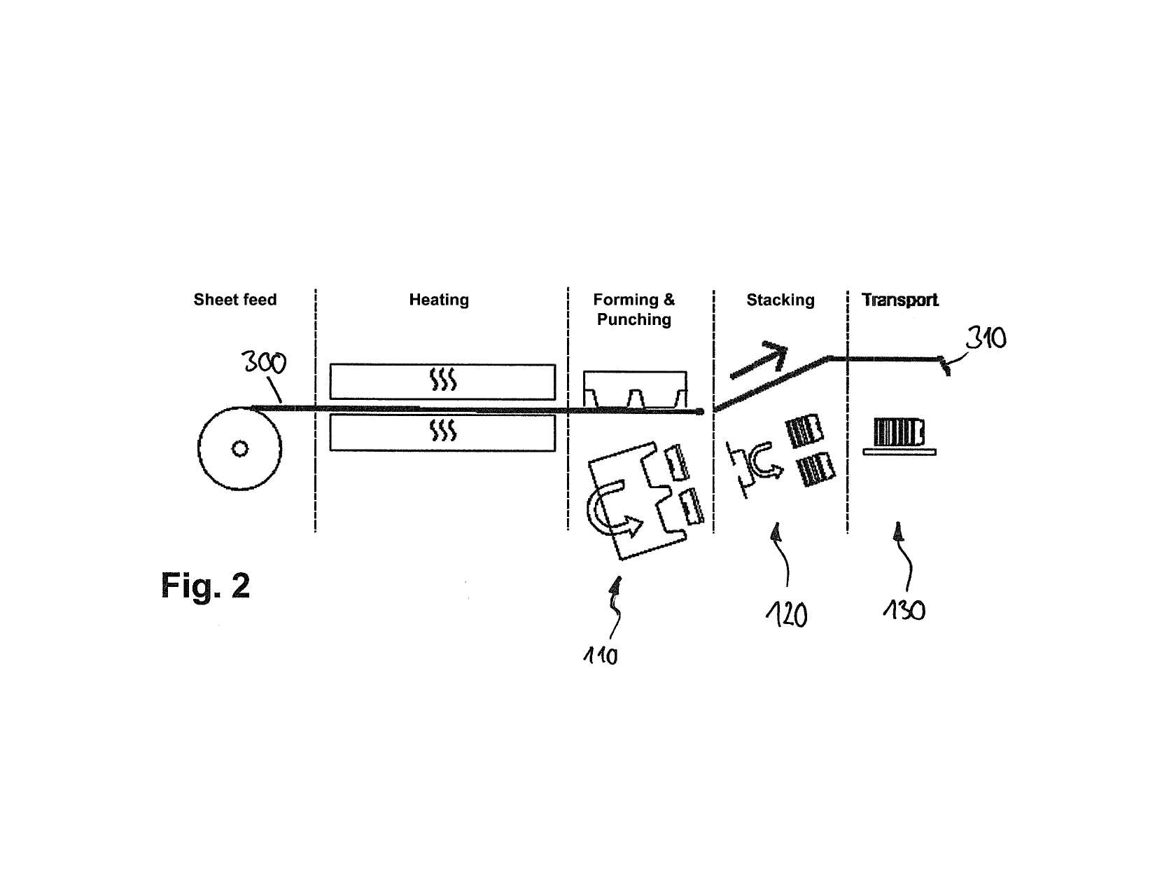

FIG. 2 depicts a schematic illustration of a forming process in a thermoforming machine 100 during the production of molded parts in a thermoforming process. A sheet 300 is fed into the thermoforming machine 100 from a sheet feed. The sheet 300 is preheated in a heating station and then transferred to the forming station 110. In the forming station 110, the sheet 300 is formed and punched. The molded parts formed and punched from the sheet 300 are then stacked in a stacking basket, which is part of a transfer and stacking station 120. Stacks of molded parts are transferred from the stacking basket to a transport unit 130, which further processes the stacked molded parts. For example, the molded parts can be packed in stacks in boxes.

The forming station 110 has a forming tool with a tiltable forming tool part and a stationary forming tool part. The tiltable forming tool part is pressed against a stationary forming tool part for forming. The tiltable forming tool part is then moved relative to the stationary forming tool part and tilted about an axis running substantially orthogonal to the feed direction of the sheet 300, where in the tilted position, the molded parts, which are accommodated in cavities of the forming tool part, are pushed into receiving compartments of the stacking basket via a further device, such as a so-called “picker”. The stacks are then transferred to the downstream transport unit 130.

Typically, before the start of a forming process, a sheet 300 is guided through the stations of the thermoforming machine 100. This occurs automatically after being inserted into a transport system through the stations until the beginning of the sheet 300 has passed the forming station 110. The beginning of the sheet 300 is then located between the forming station 110 and the transfer and stacking station 120. However, it is necessary to guide the sheet 300 through the transfer and stacking station 120 and, if necessary, other stations and to feed it to a downstream station. In the prior art, this is achieved by an operator grasping the beginning of the sheet 300 and manually guiding the sheet 300 through the stations using a ladder or by entering the thermoforming machine 100. The beginning of the sheet 300 is then fed to a winding station, for example.

The apparatus 200 for transferring the sheet 300, in contrast, offers the possibility of providing a safe and automated transfer of the beginning of a sheet before the start of a thermoforming process.

For this purpose, the apparatus 200 has a guide 210 and a transport device 230 (e.g., transport means) that can be displaced along the guide 210 and that can grip the beginning of a sheet and guide it along the guide 210 to further stations, such as the transfer and stacking station 120. After passing the transfer and stacking station 120, the beginning of the sheet is automatically released and can be fed to a skeleton mill or a rewinding station. Feeding a skeleton mill or a rewinding station can be done manually or automatically after the beginning of the sheet has been released.

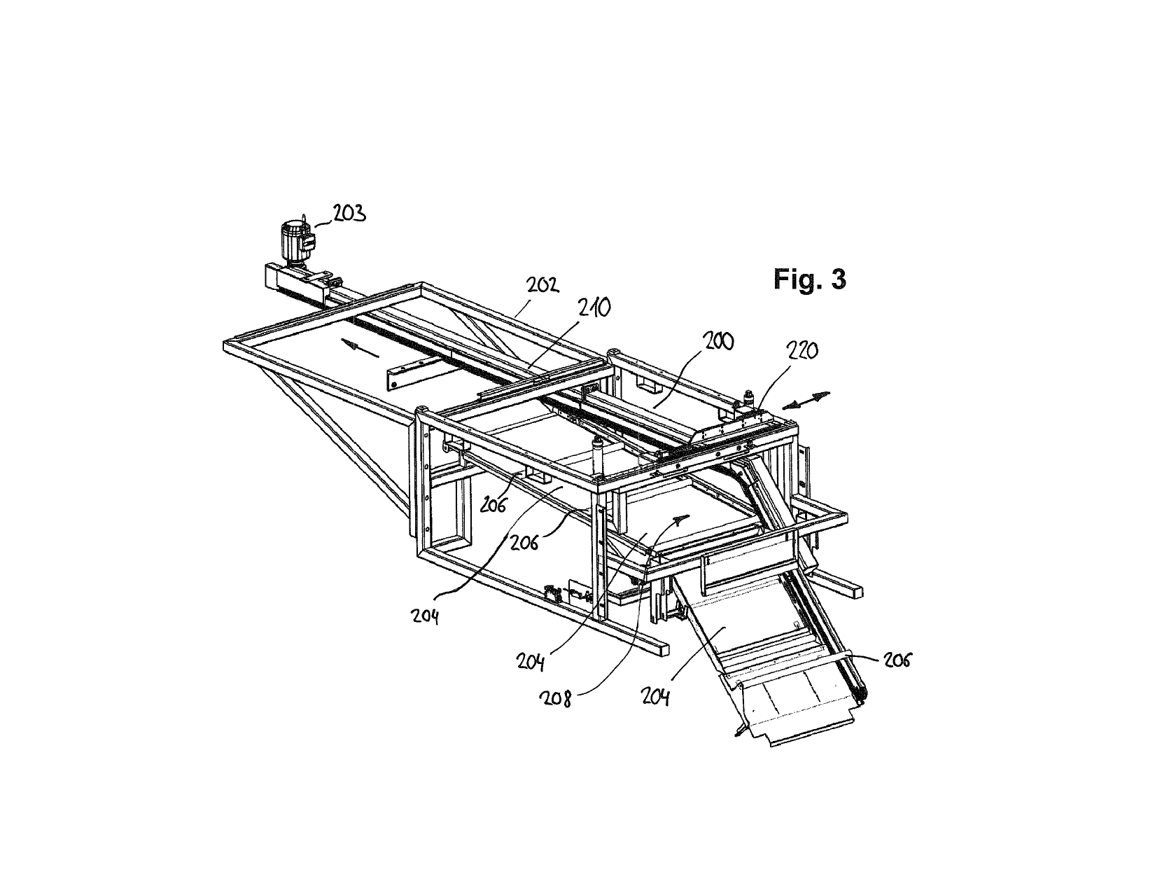

FIG. 3 depicts a schematic illustration of an apparatus 200 for transferring a material web or a sheet 300 in a perspective view. The apparatus 200 is arranged on a frame 202 of the thermoforming machine 100 and can be displaced orthogonally to the feed direction of the sheet 300 via an adjustment unit 220. For this purpose, the guide 210 can also be arranged displaceably on the frame 202. The adjustment unit 220 has a linear drive. After the sheet 300 has been transferred, the apparatus 200 can be moved out of a transport region 208 via the linear drive and adapted to different sheet widths. Since the apparatus 200 is no longer required after the sheet 300 has been transferred, it can be displaced laterally outwardly by the linear drive or, in further embodiments, by another drive device, so that the sheet 300 or a skeleton 310 no longer has to be guided through a guide slot of the guide 210 and can be guided freely over rollers 206. On the other hand, in a thermoforming machine 100, sheets 300 of different widths can be processed, so that by a lateral displacement of the apparatus 200 an adaptation to the sheet width for a sheet transfer through the apparatus 200 is possible.

As shown in FIG. 3, rollers 206 and protective plates 204 are arranged on the frame 202 in the transport region 208 of the sheet 300 or the skeleton 310. The skeleton 310 is guided over the rollers 206 and secured against sagging downwards into the region of the transfer and stacking station 120. The protective plates 204 also prevent the skeleton 310 from sagging.

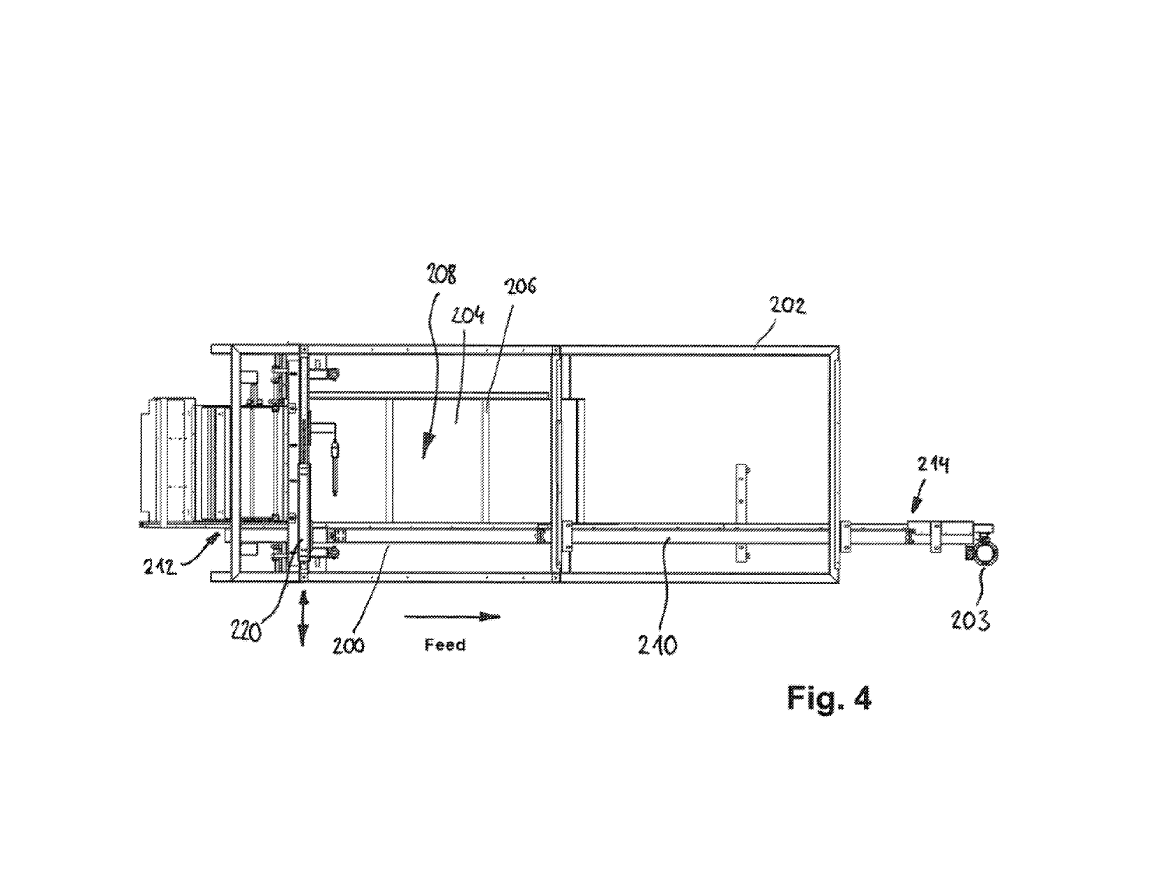

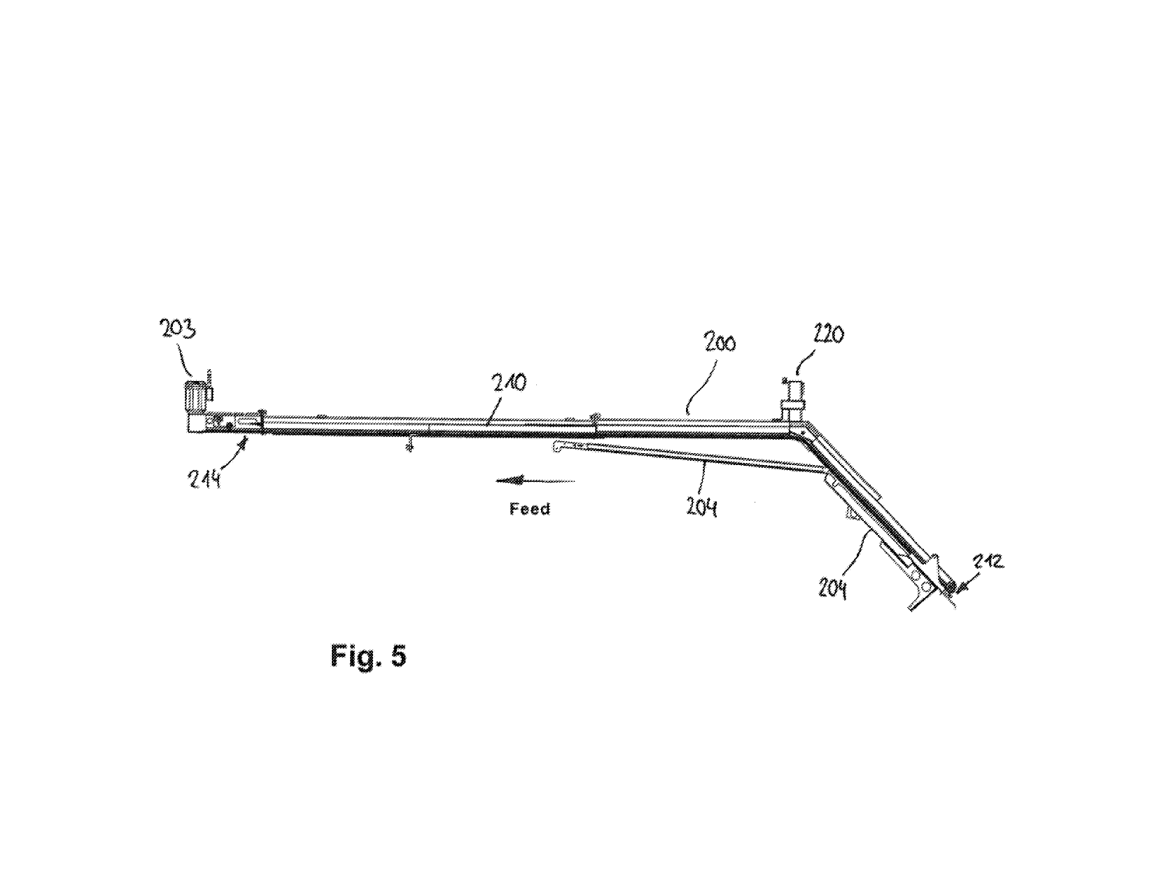

The guide 210 extends from a first region 212 in the immediate vicinity of the forming station 110 to a second region 214 after the transfer and stacking station 120 (see FIG. 1). FIG. 4 is a further illustration of the apparatus 200 from FIG. 3 from above. FIG. 5 is a further illustration of the apparatus from FIG. 3. During transfer through the apparatus 200, the sheet 300 is moved along the guide 210 and cannot sag as much as after the transfer and guidance over the rollers 206.

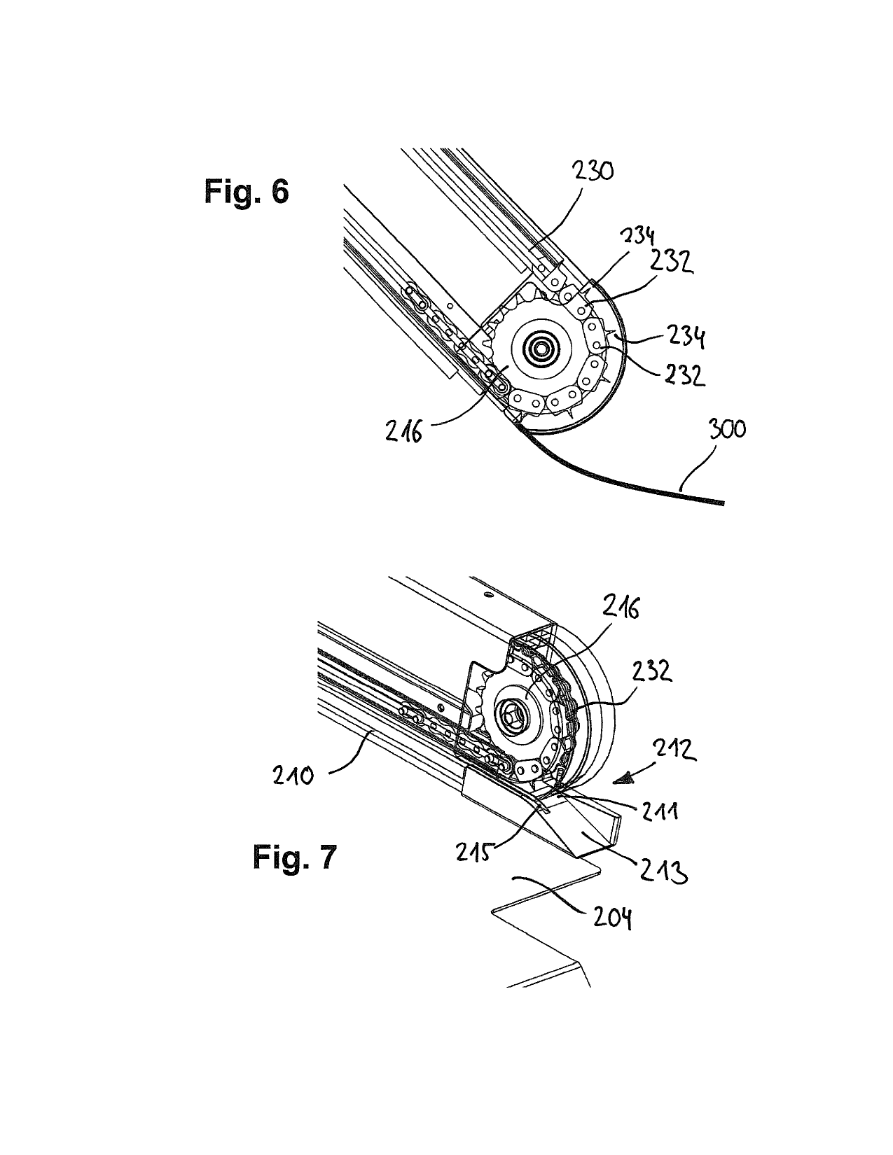

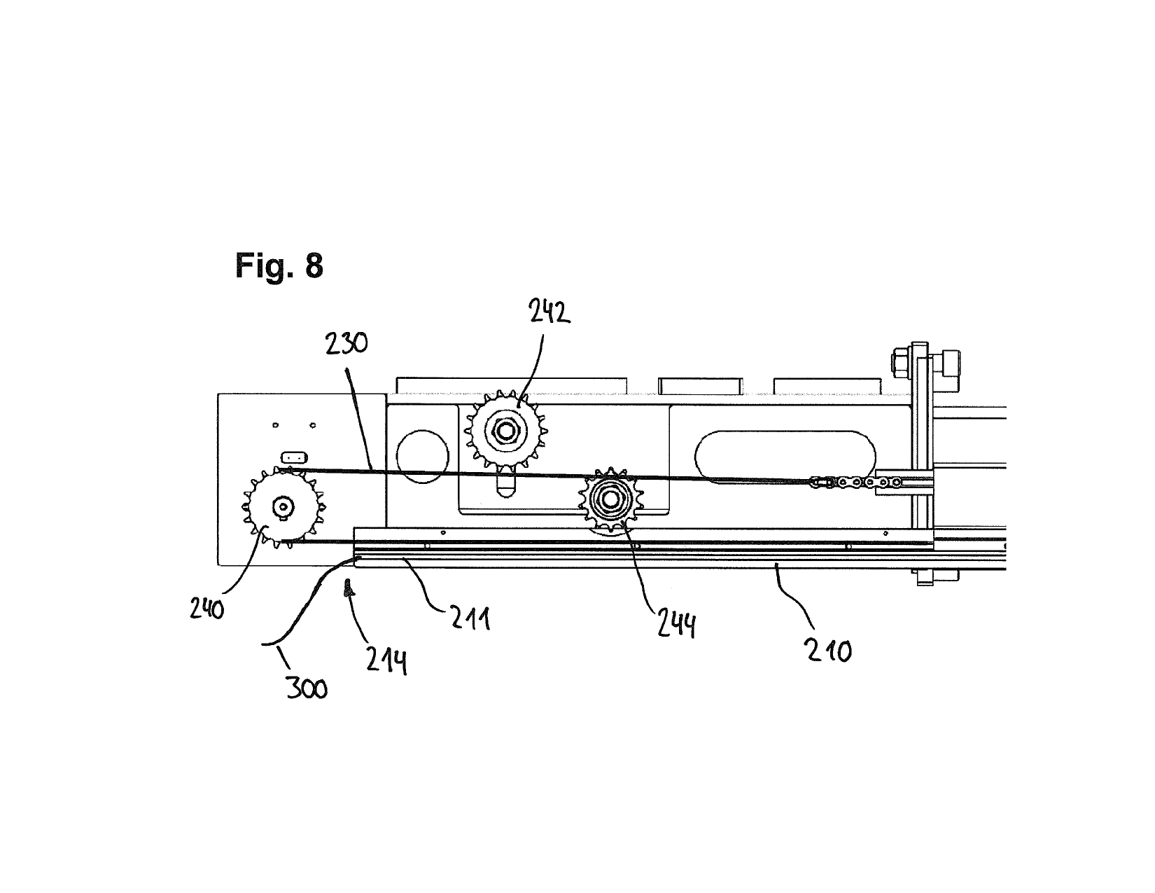

FIG. 6 is an enlarged, schematic view of the first region 212 of the apparatus 200 for transferring the sheet 300. The transport device 230 is endless and can be, for example, a chain, a belt or the like. In the exemplary embodiment shown, the transport device 230 is a chain. The chain is guided over at least two gears 216 and 240 (see FIG. 8). For this purpose, a motor 203 is provided that drives the gear 240. Some of the chain links 232 of the chain have needles 234 (e.g., teeth). As a result, the beginning of the sheet is brought into contact with the transport device 230 and can be moved along the guide 210. The design of the chain with needles 234 provided only in certain regions on some of the chain links 232 has the advantage that the chain automatically releases the sheet after transfer in the second region 214, eliminating any connection between the transport device 230 and the sheet 300. It is sufficient if the transport device 230 or the chain has needles 234 only in a relatively short portion. Such a portion can be, for example, between 1/10 and 1/100, preferably less than 1/100, of the length of the guide 210 or the entire chain length. It is essential that the transport device 230 can grip the beginning of the sheet and transport it safely along the guide 210. For this reason, in other embodiments it is sufficient if only one holding element (e.g., a needle) is provided.

Since the apparatus 200 is moved out of the transport region 208 after the sheet 300 has been transferred, the drive of the chain can be stopped after the transfer has been completed. In further embodiments, the chain continues to be driven after the sheet 300 has been transferred until the portion with the needles 234 has reached the first region 212. Preferably, the chain is stopped before the needles 234 are in the first region 212, so that after the chain starts, the needles 234 only reach the region 212 and securely grip the sheet 300. This ensures that the needles 234 have not already passed the first region 212 before the beginning of the sheet has been introduced into the first region 212.

The chain can be driven after the transfer has taken place while the apparatus 200 has not yet been displaced laterally via the adjustment unit 220, during the displacement via the adjustment unit 220 or only after the lateral displacement by the adjustment unit 220 has taken place.

FIG. 7 is a further illustration of the first region 212 in a perspective view. The guide 210 here has a ramp 213. The ramp 213 facilitates the insertion of the beginning of a sheet 300. The beginning of the sheet can be fed in by an operator, for example. The operator grasps the end of the sheet that has passed the forming station 110 and guides it into the first region 212. The ramp 213 facilitates the insertion of the beginning of the sheet. In further embodiments, the insertion of the beginning of the sheet into the first region 212 can take place without additional intervention by an operator. In yet further embodiments, the first region 212 directly adjoins a region of the forming station 110 from which the sheet 300 and, during operation of the thermoforming machine 100, the skeleton 310 are discharged. The forming station 110 itself typically has an integrated sheet or skeleton guide. Advantageously, the guide 210 and the first region 212 can directly adjoin this sheet or skeleton guide, so that a sheet 300 is automatically and positively guided from the sheet or skeleton guide into the first region 212. For this purpose, the apparatus 200 can have an additional guide aid that is designed as a connecting piece between the sheet or skeleton guide and the guide 210. In such embodiments, safety for operating personnel is further increased because no intervention in the region of the forming station 110 is required.

In the embodiment shown, a guide surface 211 of the guide 210 begins at the ramp 213 and runs along the guide 210 to the second region 214. The guide surface 211 has a groove 215 for the needles 234, which extends over the entire length of the guide surface 211. When the needles 234 engage in the sheet 300, the needles 234 penetrate the edge of the sheet 300. The sheet 300 is thereby moved together with the needles 234 when the chain is displaced. The needles 234 engage in the groove 215 so that the sheet 300 is pushed in the direction of the chain links 232. This prevents the sheet 300 from slipping.

As the sheet 300 is transported along the guide 210, the sheet 300 slides on the guide surface 211. In the exemplary embodiment shown, the guide 210 has a cover for the chain and a lateral limitation for the lateral end of the sheet 300. However, it is not necessary to limit the sheet 300 laterally by a separate guide, since the sheet 300 can also be held in position laterally by the needles 234. Depending on the engagement points, i.e. the number of needles (e.g., teeth) or retaining elements and the length of the portion with retaining elements, a lateral compensating movement of the sheet 300 is prevented.

FIG. 8 is a schematic illustration of the second region 214 of the apparatus 200 for transferring the sheet 300. The driven gear 240 and two gears 242, 244 for tensioning the chain are shown.

As shown in FIG. 8, the guide 210 ends in the second region 214, so that the sheet 300 no longer rests on the guide surface 211 when or while reaching the second region 214. The sheet 300 falls downward due to gravity and slides out of the needles 234, thus completing the transfer process. The sheet 300, or the beginning of the sheet 300, can then be fed into a skeleton mill or a rewinding station. The sheet 300 is no longer carried by the transport device 230 or the chain as soon as all needles 234 or holding elements are no longer in engagement with the sheet 300.

The transfer process is then completed and the apparatus 200 can be moved laterally out of the transport region 208 via the adjustment unit 220. In addition, the chain is displaced until the needles 234 have reached the first region 212 again, so that the sheet 300 can be transferred again during a format change and the insertion of a new sheet 300, which requires manual transfer.

### LIST OF REFERENCE SIGNS

100 Thermoforming machine

110 Forming station

120 Transfer and stacking station

130 Transport unit

200 Apparatus

202 Frame

203 motor

204 Protective plate

206 Roller

208 Transport region

210 Guide

211 Guide surface

212 First region

213 Ramp

214 Second region

215 Groove

216 Gear

220 Adjustment unit

230 Transport device (chain, belt, etc.)

232 Chain link

234 Needle

240 Gear

242 Gear

244 Gear

300 Sheet

310 Skeleton

1. An apparatus for transferring a material web in a thermoforming machine with a forming tool that can be tilted about an axis running transversely to a feed direction of the material web during a forming process, from a forming region of the forming tool of the thermoforming machine to a downstream station of the thermoforming machine, comprising a guide for the material web that is configured such that the guide extends from the forming region to the downstream station, and a transport unit with a transport device that is configured to be displaced along the guide between the forming tool and the downstream station and configured to be engaged with the material web in a first region facing the forming tool and configured to be disengaged in a second region facing the downstream station.

2. The apparatus according to claim 1, wherein the transport device has at least one holding element for engagement.

3. The apparatus according to claim 2, wherein the transport device is endless and only a portion of the transport device has the at least one holding element.

4. The apparatus according to claim 2, wherein the at least one holding element has a needle and/or a clamping element, and/or the transport device is configured at least in portions as a chain, belt, or strap.

5. The apparatus according to claim 1, further comprising an adjustment unit for a relative displacement of the transport device.

6. The apparatus according to claim 1, wherein the transport device is configured to be displaced orthogonally to a feed direction of the material web through the thermoforming machine.

7. The apparatus according to claim 1, wherein the transport device is configured to be pivoted relative to an axis extending orthogonally to a feed direction of the material web through the thermoforming machine.

8. A thermoforming machine with a forming tool that can be tilted about an axis running transversely to a feed direction of a material web during a forming process, and a transfer apparatus for transferring the material web from a forming region of the forming tool of the thermoforming machine to a downstream station of the thermoforming machine, the transfer apparatus comprising:
a transport unit with a transport device that is configured to be displaced along a guide between the forming tool and the downstream station and configured to be engaged with the material web in a first region facing the forming tool and configured to be disengaged in a second region facing the downstream station.

9. The thermoforming machine according to claim 8, wherein at least one further station is arranged between the forming tool and the downstream station and a guide of the transfer apparatus leads past the at least one further station.

10. A method for transferring a material web from a forming region of a thermoforming machine with a forming tool and with a transfer apparatus for transferring the material web, wherein the forming tool is tilted about an axis running transversely to a feed direction of the material web during a forming process, and wherein the material web is transported from a forming region of the forming tool of the thermoforming machine to a downstream station of the thermoforming machine,
wherein the transfer apparatus comprises a transport unit with a transport device that is displaced in a first direction via a guide between the forming tool and the downstream station and is engaged with an initial portion of the material web in a first region facing the forming tool and is disengaged in a second region facing the downstream station.

11. The method according to claim 10, wherein the transport device is displaced in a further direction relative to the guide and/or is stopped when the material web has passed the second region.

12. The method according to claim 10, wherein during the displacement of the transport device in the first direction at least one holding device of the transport device is automatically engaged with the material web when the at least one holding device passes or has passed the first region and is automatically disengaged when the at least one holding device passes or has passed the second region.
